(19) United States
(12) Patent Application Publication
(10) Pub. No.: US 2025/0385835 A1
(43) Pub. Date: Dec. 18, 2025

(54) NETWORK DEPLOYMENT RECOMMENDATION USING MACHINE LEARNING

(71) Applicant: Dell Products L.P., Round Rock, TX (US)

(72) Inventors: Bijan Kumar Mohanty, Austin, TX (US); David J. Linsey, Marietta, GA (US); Hung Dinh, Austin, TX (US)

(21) Appl. No.: 18/743,286

(22) Filed: Jun. 14, 2024

(51) Int. Cl. H04L 41/0806; G06F 8/60; H04L 41/16

(52) U.S. Cl. CPC H04L 41/0806; G06F 8/60; H04L 41/16

(57) ABSTRACT

A method comprises receiving a request to predict a deployment configuration for at least one application, analyzing code of the at least one application to identify one or more additional applications on which the at least one application will depend, identifying a plurality of network paths between the at least one application and the one or more additional applications, and using one or more machine learning algorithms to predict execution times for the at least one application over the plurality of network paths. The predicted execution times for the at least one application over the plurality of network paths are inputted to a network graph model. The network graph model predicts the deployment configuration for the at least one application based at least in part on the predicted execution times, wherein the deployment configuration comprises a subset of the plurality of network paths.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to network deployment recommendation in information processing systems.

### BACKGROUND

Cloud-based software deployments provide software developers with a variety of options for network deployment strategies. For example, network deployment configurations can be based on region and availability, and may include multi-cloud deployments. As a result, there may be a larger number of network paths for an application, resulting in complex network deployment configurations. Moreover, given the increased number of cloud native microservices, micro-frontend (MFE) applications and function-as-a-service (FaaS) applications, it can be very difficult for a developer to truly understand, in advance, how an application's integration and network call footprint will be integrated into an ecosystem.

### SUMMARY

Embodiments provide a network deployment recommendation platform in an information processing system.

For example, in one embodiment, a method comprises receiving a request to predict a deployment configuration for at least one application, analyzing code of the at least one application to identify one or more additional applications on which the at least one application will depend, identifying a plurality of network paths between the at least one application and the one or more additional applications, and using one or more machine learning algorithms to predict execution times for the at least one application over the plurality of network paths. The predicted execution times for the at least one application over the plurality of network paths are inputted to a network graph model. The network graph model predicts the deployment configuration for the at least one application based at least in part on the predicted execution times for the at least one application over the plurality of network paths, where the deployment configuration comprises a subset of the plurality of network paths.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a network deployment recommendation platform according to an illustrative embodiment.

FIG. 2 depicts an architecture including different deployment environments for a microservice according to an illustrative embodiment.

FIG. 3 depicts an architecture including a multi-cloud application with multiple datastore dependencies according to an illustrative embodiment.

FIG. 4A depicts a table of response time and successful request metrics for different application connections according to an illustrative embodiment.

FIG. 4B depicts a table of applications and their corresponding fingerprints according to an illustrative embodiment.

FIG. 5 depicts an operational flow for network path prediction according to an illustrative embodiment.

FIG. 6 depicts example pseudocode for identifying dependencies for a microservice according to an illustrative embodiment.

FIG. 7 depicts example pseudocode for capturing execution time of services according to an illustrative embodiment.

FIG. 8A depicts example pseudocode for importation of libraries and for loading historical execution time data into a data frame according to an illustrative embodiment.

FIG. 8B depicts example historical execution time data according to an illustrative embodiment.

FIG. 9A depicts example pseudocode for compiling unique historical execution time data between services according to an illustrative embodiment.

FIG. 9B depicts example unique historical execution time data between services according to an illustrative embodiment.

FIG. 10 depicts example pseudocode for encoding a dataset for machine learning according to an illustrative embodiment.

FIG. 11 depicts example pseudocode for splitting a dataset into training and testing components and for creating separate datasets for independent and dependent variables according to an illustrative embodiment.

FIG. 12 depicts example pseudocode for creating a random forest regressor and training the machine learning model according to an illustrative embodiment.

FIG. 13A depicts example pseudocode for using the trained machine learning model to predict execution time for various service combinations according to an illustrative embodiment.

FIG. 13B depicts predicted execution times for various service combinations according to an illustrative embodiment.

FIG. 14A depicts example pseudocode for leveraging a network graph model to predict optimal network paths according to an illustrative embodiment.

FIG. 14B depicts a predicted optimal network path according to an illustrative embodiment.

FIG. 15 depicts a process for network deployment prediction according to an illustrative embodiment.

FIGS. 16 and 17 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a requesting device receives messages without any significant time delay. Of course, it should be understood that depending on the particular temporal nature of the system in which an embodiment is implemented, other appropriate timescales that provide at least contemporaneous performance and output can be achieved.

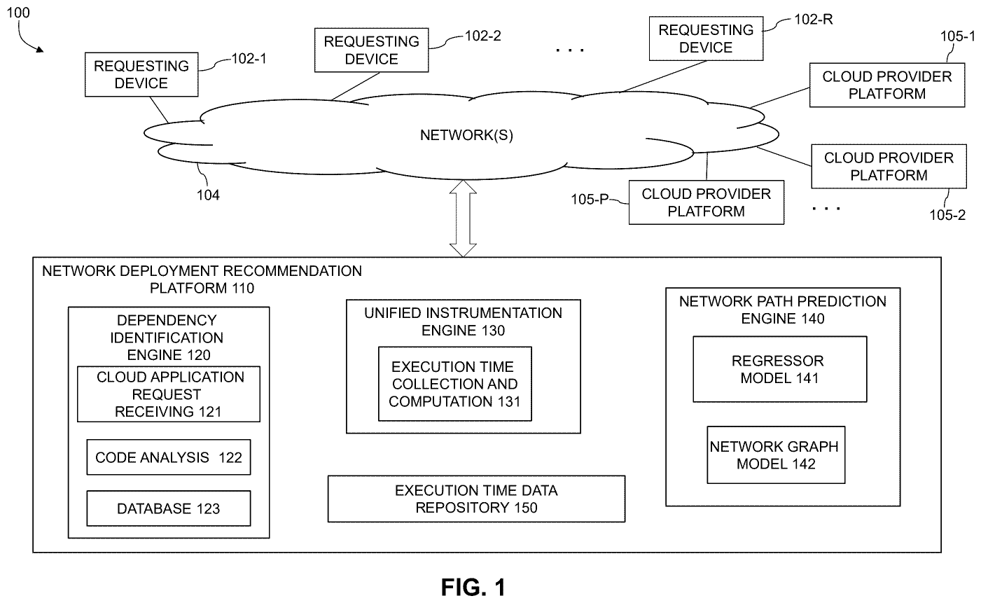

FIG. 1 shows an information processing system 100 configured in accordance with an illustrative embodiment. The information processing system 100 comprises requesting devices 102-1, 102-2, . . . 102-R (collectively “requesting devices 102”) and cloud provider platforms 105-1, 105-2, . . . 105-P (collectively “cloud provider platforms 105”). The requesting devices 102 and cloud provider platforms 105 communicate over a network 104 with a network deployment recommendation platform 110. The variable R and other similar index variables herein such as L, P and Q are assumed to be arbitrary positive integers greater than or equal to one.

The requesting devices 102 and one or more devices of the cloud provider platforms 105 can comprise, for example, Internet of Things (IoT) devices, server, desktop, laptop or tablet computers, mobile telephones, or other types of processing devices capable of communicating with the network deployment recommendation platform 110 over the network 104. Such devices are examples of what are more generally referred to herein as “processing devices.” Some of these processing devices are also generally referred to herein as “computers.” The requesting devices 102 and one or more devices of the cloud provider platforms 105 may also or alternately comprise virtualized computing resources, such as virtual machines (VMs), containers, etc. The requesting devices 102 and/or one or more devices of the cloud provider platforms 105 in some embodiments comprise respective computers associated with a particular company, organization or other enterprise.

The terms “customer,” “administrator,” “personnel” or “user” herein are intended to be broadly construed so as to encompass numerous arrangements of human, hardware, software or firmware entities, as well as combinations of such entities. Network deployment recommendation services may be provided for users utilizing one or more machine learning models, although it is to be appreciated that other types of infrastructure arrangements could be used. At least a portion of the available services and functionalities provided by the network deployment recommendation platform 110 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the network deployment recommendation platform 110, as well as to support communication between the network deployment recommendation platform 110 and connected devices (e.g., requesting devices 102 and one or more devices of the cloud provider platforms 105) and/or other related systems and devices not explicitly shown.

In some embodiments, the requesting devices 102 are assumed to be associated with repair technicians, system administrators, information technology (IT) managers, software developers, release management personnel or other authorized personnel configured to access and utilize the network deployment recommendation platform 110. The requesting devices 102 can also be respectively associated with one or more customers requiring the services of one or more cloud providers. Some non-limiting examples of cloud providers that may correspond to the cloud provider platforms 105 include, but are not necessarily limited to, Amazon® Web Services (AWS®), Azure®, Google® Cloud Platform (GCP®), Oracle® and/or Dell® APEX® cloud providers.

As noted hereinabove, the number of network paths for an application can be large, resulting in complex network deployment configurations. With the increased number of cloud native microservices, MFE applications and FaaS applications, deployment configuration selection has become increasingly complex. For example, with current approaches, performance while testing can assist in discovering some behavior, the complexity and multi-tenant nature of cloud environments often means production behavior cannot be fully simulated. Additionally, complete and exhaustive performance testing of every change is often costly and not practicable.

In order to address the problems with current approaches, illustrative embodiments provide technical solutions which use machine learning to intelligently recommend network deployment configurations and optimum cloud providers for different applications. For example, depending on application dependencies, different applications may require different services, resulting in different network paths and use of different cloud providers. The embodiments advantageously provide a network deployment recommendation framework that permits intelligent prediction of network deployments based on service execution time. The embodiments provide a network deployment recommendation framework which allows developers to proactively visualize and quantify network calls including, for example, specific end points, number of hops and crossing of cloud platforms for a given application. Leveraging machine learning, the framework predicts service execution time and/or latency for a new cloud-native application (e.g., microservice, MFE, etc.) and optimal network paths based on the predicted service execution time and/or latency.

The network deployment recommendation platform 110 in the present embodiment is assumed to be accessible to the requesting devices 102 and/or cloud provider platforms 105 and vice versa over the network 104. The network 104 is assumed to comprise a portion of a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Referring to FIG. 1, the network deployment recommendation platform 110 includes a dependency identification engine 120, a unified instrumentation engine 130, a network path prediction engine 140 and an execution time data repository 150. The dependency identification engine 120 includes a cloud application request receiving layer 121, a code analysis layer 122 and a database 123. The unified instrumentation engine 130 includes an execution time collection and computation layer 131. The network path prediction engine 140 includes a regressor model 141 and a network graph model 142.

The cloud application request receiving layer 121 of the dependency identification engine 120 receives cloud application requests from one or more requesting devices 102. In a non-limiting illustrative embodiment, the cloud application request receiving layer 121 receives automated requests from applications running on the requesting devices 102 or requests initiated by one or more users of the requesting devices 102. The requests include a request to predict a deployment configuration for at least one application, and further includes code of the application. As explained hereinbelow, the code of the application is analyzed by the code analysis layer 122 to determine dependencies of the application (e.g., one or more additional applications on which the application will depend). As noted herein above, the application can be, for example, a microservice, an MFE application or an FaaS application.

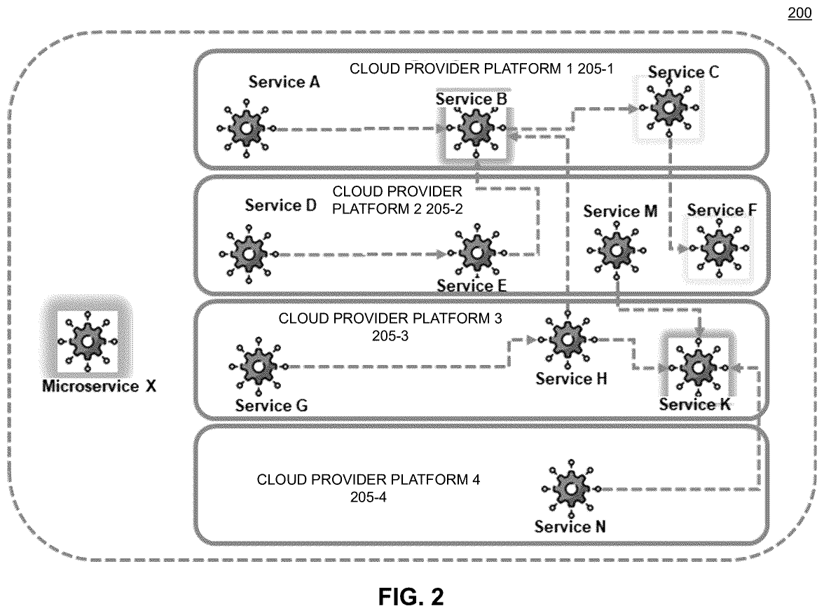

Referring, for example, to the architecture 200 in FIG. 2, a new microservice X is being deployed and a decision needs to be made in which the deployment environment (e.g., cloud provider platform 1 205-1, cloud provider platform 2 205-2, cloud provider platform 3 205-3 or cloud provider platform 4 205-4) the new microservice X should be deployed. In this instance, the cloud application request receiving layer 121 receives a request to predict a deployment configuration for the new microservice X. Cloud provider platform 1 205-1, cloud provider platform 2 205-2, cloud provider platform 3 205-3 and cloud provider platform 4 205-4 may collectively be referred to as cloud provider platforms 205 and can be the same as or similar to cloud provider platforms 105.

In accordance with an illustrative embodiment, the request includes code of the new microservice X. The code analysis layer 122 analyzes the microservice code to identify whether the service calls other services. While some services can be atomic in nature, many microservices or other applications may be composite services that call one or more other services to, for example, receive data or perform other functions. In illustrative embodiments, the code analysis layer 122 uses static code analysis tools like SonarQube® and/or other custom analysis tools to identify the dependencies for an application (e.g., new microservice X). In addition, the code analysis layer 122 analyzes the code of the services from which the new application depends to identify the dependencies for those services and so on. For example, in case of service A calling service B and service C, the code analysis layer 122 can identify the dependencies which will be factored in a call execution path of service A.

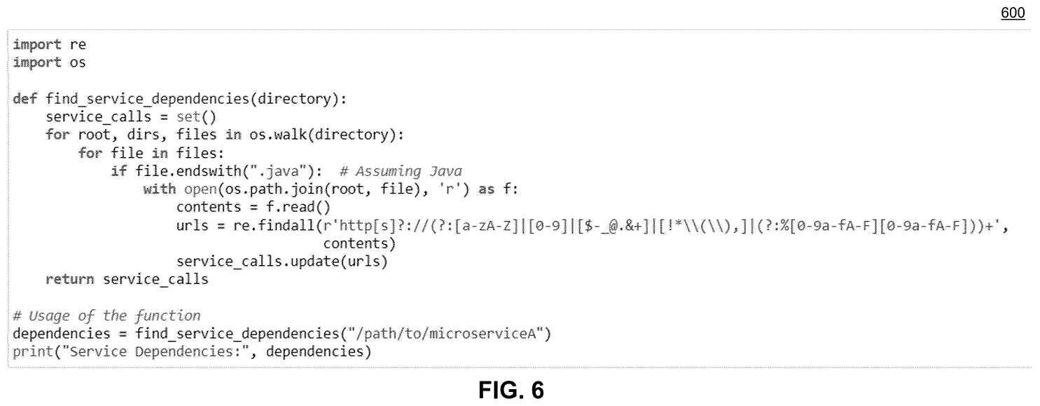

FIG. 6 depicts example pseudocode 600 for identifying dependencies for a microservice. For example, the pseudocode 600 illustrates a custom Python code snippet for identifying dependencies in a microservice written in Java®. For microservices written using languages other than Java®, necessary changes can be made to the code to make it compatible with the other languages. According to the Python script of the pseudocode 600, the codebase is scanned to find dependencies on other microservices from microservice A. The pseudocode 600 uses regular expressions and, when executed, identifies protocol (e.g., HTTP) patterns in the code corresponding to a typical service call. The identified dependencies are stored in a database 123, which can then be used to create a visualization of a call path chain.

For example, referring back to the architecture 200, the new microservice X invokes two other services (Service B and Service K), which are outlined. Service B invokes Service C, which, in turn, invokes Service F. As can be understood, as would be identified by the code analysis layer 122, invoking Service B involves executing Service C and Service F.

Referring to the architecture 200 in FIG. 2, as would be further identified by the code analysis layer 122, there are 3 possible paths to reach Service B. A first path is through Service A in cloud provider platform 1 205-1. A second path is through Service E in cloud provider platform 2 205-2, and a third path is through Service H in cloud provider platform 3 205-3. In the case of Service K, Service K can be reached from cloud provider platform 2 205-2 through Service M, from cloud provider platform 3 205-3 through Service H or from cloud provider platform 4 205-4 through Service N. Given this dependency information, the remainder of the network deployment recommendation platform 110 (e.g., unified instrumentation engine 130 and network path prediction engine 140) can be used to determine the optimized network path for invoking both Service B and Service K from new microservice X when new microservice X is deployed. Based on the predicted optimal network path, a software developer can device where new microservice X should be deployed.

The illustrative embodiments provide a network deployment recommendation platform 110 that utilizes static code analysis tools to identify application dependencies, which are captured and stored in a database (e.g., database 123) so that the dependencies can be used to generate visualizations in the form of call path graphs. The unified instrumentation engine 130 of the network deployment recommendation platform 110 leverages unified instrumentation in the applications to capture and compute execution times of respective network paths between dependent applications in a multi-cloud environment. Once the execution time of each network path is computed in a run-time environment, the network deployment recommendation platform 110 leverages the regressor model 141 and network graph model 142 to recommend the optimized call path for a given application, thus enabling the decision where to deploy the new application.

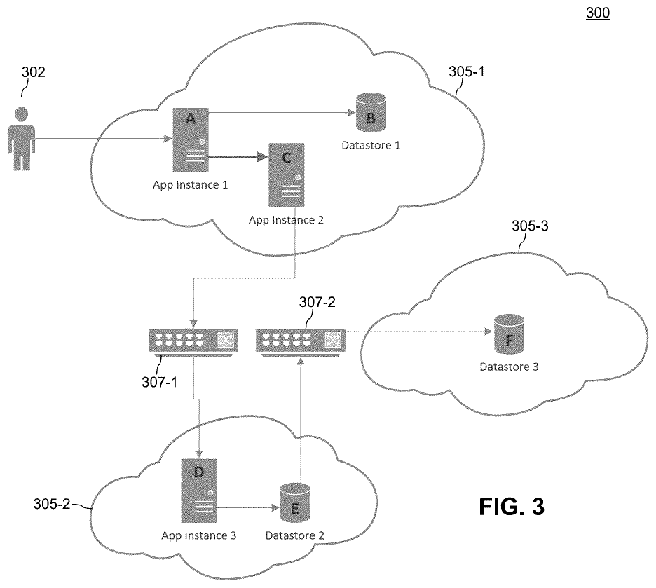

In another example, FIG. 3 depicts an architecture 300 including a multi-cloud application with multiple datastore dependencies. In more detail, the architecture 300 includes multiple chained microservices (e.g., App Instance 1 (A), App Instance 2 (C), App Instance 3 (D)) each with their own datastore dependencies (e.g., Datastore 1 (B), Datastore 2 (E), Datastore 3 (F)). App Instance 1 connects to Datastore 1 and to App Instance 2 within the same cloud environment (cloud provider platform 305-1). A call to App Instance 2 has additional cascading dependencies, including calls which traverse into other cloud platforms (cloud provider platform 305-2 and cloud provider platform 305-3) through, for example, routers 307-1 and 307-2. In this case, a developer 302 who owns App Instance 1 may not realize the amount of overhead and risk they are adding to their application by making the seemingly simple additional connection to App Instance 2. Additionally, synthetic performance testing may not identify issues due to the multi-cloud nature of this integration, which is unlikely to be fully reflected in a test environment. It is advanced awareness and quantification of this overhead and risk based on expected production environment behavior the illustrative embodiments address. Cloud provider platform 305-1, cloud provider platform 305-2 and cloud provider platform 305-3 may collectively be referred to as cloud provider platforms 305 and can be the same as or similar to cloud provider platforms 105 and/or 205.

In a multi-cloud environment, where the service call paths can span across different cloud providers (e.g., cloud provider platforms 105/205/305), the execution time collection and computation layer 131 of the unified instrumentation engine 130 captures the execution time between each application call (e.g., microservice call) and computes the overall execution time of an application (e.g., microservice), which includes the execution times of the dependencies of the application. The execution time collection and computation layer 131 uses unified instrumentation with a centralized data aggregation approach to capture the execution time between each application call and to compute the overall execution time of the application.

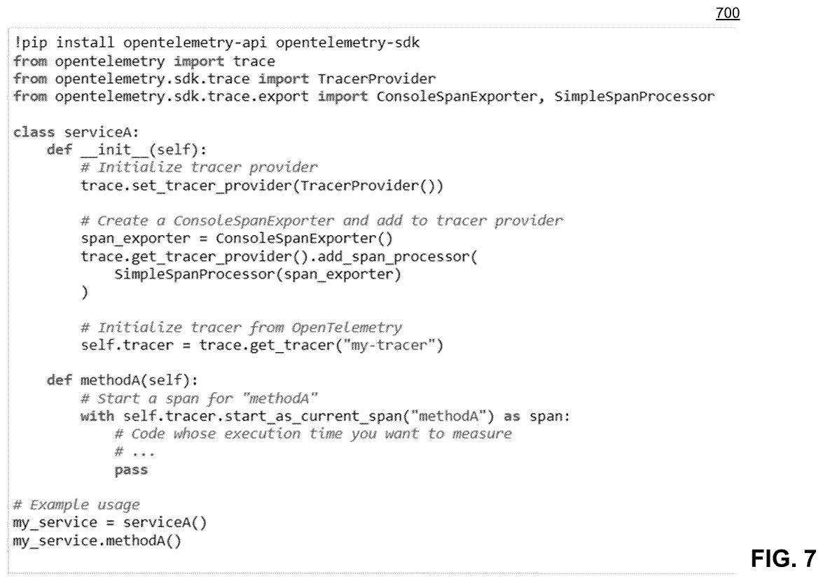

Using this approach, the illustrative embodiments adopt a consistent instrumentation strategy across all applications (e.g., microservices) regardless of the cloud provider. In illustrative embodiments, code is added to the applications (e.g., microservices) to capture execution times and the interactions with other services. In a non-limiting illustrative example, the code, which can be used across multiple cloud providers (e.g., cloud provider platforms 105/205/305) in an agnostic manner, collects traces and metrics of network paths of different applications. The code enables network paths to be traced to collect the execution times. In more detail, FIG. 7 depicts example pseudocode 700 for capturing execution times of services. The pseudocode 700 includes a python code snippet where OpenTelemetry is used to capture execution times by creating a span at the beginning of a method and closing it at the end of the method (e.g., between service endpoints or nodes). These spans are exported to a centralized system such as, for example, Prometheus or Jaeger. The pseudocode 700 illustrates generating a tracer and span in a service and method. For example, a tracer is created in a constructor to start distributed tracing in OpenTelemetry.

The execution time data for each application (e.g., microservice) in a call path is captured and managed in the execution time data repository 150, which as explained in more detail hereinbelow, is used to train the regressor model 141.

In illustrative embodiments, the execution time collection and computation layer 131 compiles and computes a mathematical measurement of the execution time and a number of successful requests served from a destination (e.g., destination B) back to a source (e.g., source A). Existing, known integrations and their behavior between sources and destinations provide an indication of future performance for services between the same endpoints or similar endpoints. Execution time measurement can be performed, at least in part, by web servers, application programming interface (API) frameworks and observability tools. The aggregation of this time is configurable within a predictive analysis framework's algorithm, and may be set to, for example, averages (e.g., mode, mean, median), minimum/maximum, and/or percentile (e.g., 95th percentile), along with configurable granularity (e.g., 15-minute granularity).

Successful requests served measurements can be performed, at least in part, by web servers, API frameworks, load balancers and observability tools. This is configurable and may be based on HTTP error codes (e.g., 2XX indicating “successful” and 4XX/5XX indicating “unsuccessful”) and/or based on specific information returned in a body, which may indicate success or failure. The aggregation of this metric is configurable within the predictive analysis framework's algorithm, and may be set to and may be set to, for example, averages (e.g., mode, mean, median), minimum/maximum, percentile (e.g., 95th percentile) and/or percent successful, along with configurable granularity (e.g., 15-minute granularity).

If there is no current integration between a given source (e.g., source A) and a given destination (e.g., destination B), but destination B is responding to requests to other sources (e.g., source C and source D), the embodiments are configured to predict metrics of a new connection between source A and destination B based on existing connections, while giving more weight to the most similar existing connections to the proposed new connection between source A and destination B. Similarly, if there is no current integration between a given source (e.g., source E) and a given destination (e.g., destination F), but source E is making requests to other destinations (e.g., destination G and destination H), the embodiments are configured to predict metrics of a new connection between source E and destination F based on existing connections, while giving more weight to the most similar existing connections to the proposed new connection between source E and destination F.

The illustrative embodiments identify similarity to and between existing clients of destination B or similarity to and between existing destinations of source E. The similarities are identified based on, for example, cyclomatic complexity, a size of code for the application, coding language, libraries used, types of integrations, algorithms and algorithmic parameters used to produce an application fingerprint. This application fingerprint is used to draw parallels between a new source client application (e.g., source A) or new destination application (e.g., destination F) and the fingerprints of existing source applications (such as source C and source D), which already communicate with destination B and can be assessed, or existing destination applications (e.g., destination G and destination H), which already communicate with source E and can be assessed. In illustrative embodiments, cyclomatic complexity may be returned by code coverage tools such as, for example, SonarQube®, etc. Cyclomatic complexity measures, for example, the number of linearly independent paths through code. For a given application, the embodiments account for code loops, branches and connected components. In connection with coding language, the embodiments consider code language(s) (e.g., JAVA, JSON, Python, etc.) used for a given application and a percentage of the number of lines of code corresponding to each development language. Different languages can have different resource overhead, especially when comparing interpreted, ahead-of-time (AOT) compiled, and just-in-time (JIT) compiled languages.

Libraries used relates to external libraries/drivers that are bound to an application. The libraries/drivers may be public or private. Fingerprint assessment of libraries bound to an application can facilitate identification of resources that are shared to run the libraries. Additionally, knowledge of certain libraries used by applications provides an indication of an ultimate purpose and behavior of an application. For example, an application using Spring Web is likely different operationally from an application using Spring for Apache Kafka.

The embodiments further consider the number and types of external integrations (e.g., data source connections, API calls in or out, connections to queues, etc.) associated with an application. For example, external integrations and their protocols (e.g., HTTPS, sockets, file, JDBC) can affect the volume of required input-output I/O operations. The embodiments also consider what functions an application may be performing such as, for example, caching and/or cryptography.

The embodiments further consider designated additional dimensions, which are manually inputted by users and have been historically deemed important for consideration, such as, for example, anticipated load, load patterns (highs and lows, seasonality), etc. Except for the manually inputted dimension, the other dimensions used in the similarity analysis can be assessed directly from analysis of existing ecosystem integrations.

The dimensions used in the similarity analysis are used to train predictive machine learning algorithms that determine an application's predicted performance changes and operational behavior for newly proposed integrations. Appropriate weight is given to each parameter and its associated values, which may be based on previous observations of applications and their behavior.

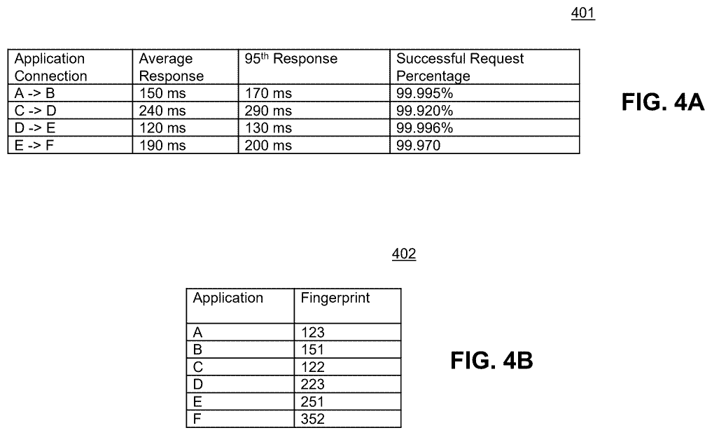

FIG. 4A depicts a table 401 of response time and successful request metrics for different existing application connections (A-B, C-D, D-E and E-F). FIG. 4B depicts a table 402 of applications (A, B, C, D, E and F) and their corresponding fingerprints. Referring to the table 401, there can be multiple samples of these metrics, (e.g., taken every 15 minutes or per a different configurable granularity), with each of these samples being fed to the machine learning algorithm of the regressor model 141 as training data. As explained herein above, application fingerprints such as those in table 402, define similarities between the individual nodes in an application ecosystem, with similar nodes having similar fingerprints. For the purposes of illustration, applications and datastores have different fingerprints from each other, as do nodes within different clouds in a multi-cloud ecosystem.

In connection with recommending a deployment configuration for a new application (e.g., microservice), which includes optimal paths and corresponding identified dependencies, the illustrative embodiments recommend a cloud provider (e.g., one of the cloud provider platforms 105/205/305) on which to deploy a new application in a multi-cloud environment. This is achieved by generating a call graph of the application and computing the cost of executing call paths that can span multiple cloud providers. If there are multiple possible groups of paths using different combinations of cloud providers, the embodiments recommend an optimized configuration that makes the most efficient use of network paths and execution time. The optimized path approach can advantageously provide insight on what microservices should be migrated from one cloud provider to another.

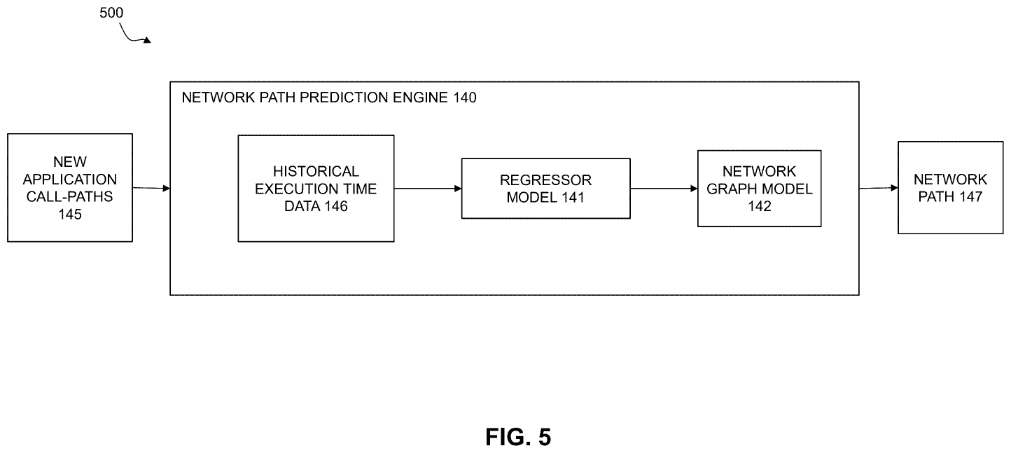

Referring FIG. 5, which depicts an operational flow 500 for network path prediction, the network path prediction engine 140 recommends an optimized path for execution of a new application call-paths 145 and its dependencies. The network path prediction engine 140 leverages a regressor model 141 and network graph model 142 to predict the network path 147, which includes a plurality of paths connecting a new application and its dependencies. The regressor model 141 is trained with historical execution time data 146 from the execution time data repository 150. The historical execution time data 146 is captured by the execution time collection and computation layer 131. As explained in more detail herein, the graph network model plots new application call-paths 145 in a weighted graph model. The call-paths may also be referred to herein as network paths. In this approach, each service (e.g., microservice) is a node in the graph, and the edges between the nodes represent the call-paths between the services, with weights indicating the time taken for each call. The weights are calculated by using the regressor model 141, which employs a regression algorithm trained with the historical execution time data 146. For example, if there are 1000 historical observations of execution time between Service A and Service B, in illustrative embodiments, a regression algorithm will use those 1000 observations to predict the optimal value of the execution time between the services. That predicted time will then be used as the weight of the edge between the nodes representing Service A and Service B in the network graph model.

In illustrative embodiments, the network graph model 142 uses the NetworkX library in Python, to create and manipulate a complex network graph. The network graph model 142 creates a graph with nodes representing a new application and dependent services (e.g., other applications) on which the new application depends and edges with weights (representing execution times) between nodes. In illustrative embodiments, the network graph model 142 uses a shortest path algorithm to find an optimized network path through each of the dependencies based on total execution time of aggregated multiple sub-network paths of the optimized network path. As mentioned hereinabove, the weights (execution times) are predicted by the regressor model 141 trained with historical execution data.

As shown in the operational flow 500, the regressor model 141 is trained with historical execution time data 146. The trained regressor model accepts the various call-paths of a new application (new application call-paths 145) as defined by the dependency identification engine 120. The new application call-paths 145 are inputted to the regressor model 141 to estimate the time taken between services in each call-path. A regressor is used instead of a hard coded values to enable dynamic values in the operational environment. These estimated values along with the call-paths of the microservice are passed to the network graph model 142 which predicts the optimal path (network path 147) of the new application based on regressed execution times. The network path 147 comprises a subset of the originally inputted new application call-paths 145. As can be understood, the new application call-paths 145 include different possible call-paths from which the subset of network paths are selected to provide the optimized execution time and use of network resources.

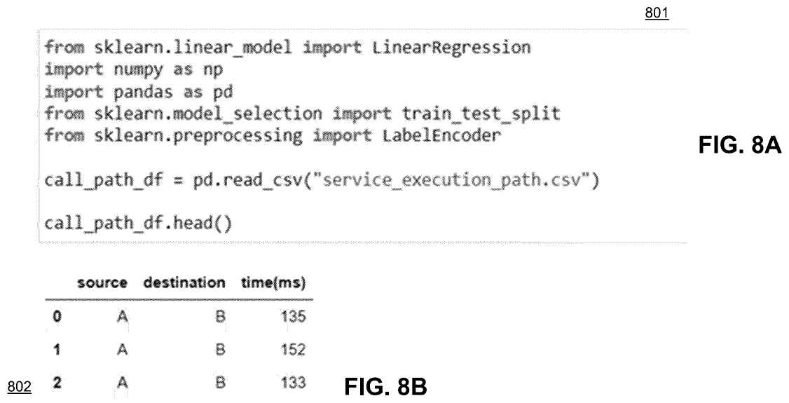

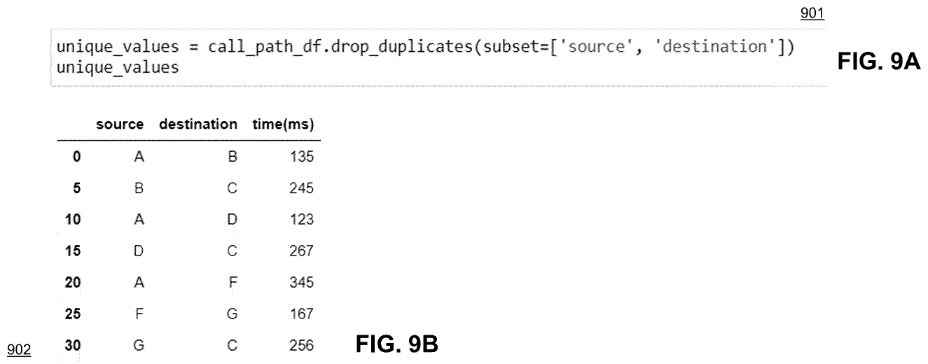

FIG. 8A depicts example pseudocode 801 for importation of libraries and for loading historical execution time data into a data frame, and FIG. 8B depicts a table 802 of example historical execution time data. In illustrative embodiments, the regressor model 141 is implemented as a random forest regressor, where Python and a ScikitLearn library are used, and the historical execution time data between various services is read as a CSV file. As can be seen in the table 802, the historical execution time data specifies execution times in milliseconds between source A and destination B in different iterations. FIG. 9A depicts example pseudocode 901 for compiling unique historical execution time data between services where duplicate values are removed. FIG. 9B depicts a table 902 of example unique historical execution time data between services where duplicate values have been removed. In the table 902, the unique historical execution time data specifies execution times in milliseconds between source A and destination B, source B and destination C, source A and destination D, source D and destination C, source A and destination F, source F and destination G, and source G and destination C.

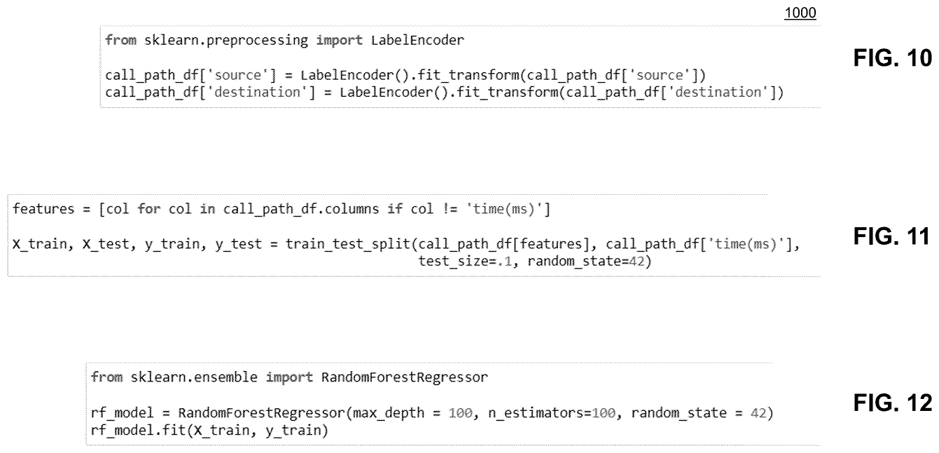

Since machine learning works with vectors (e.g., numbers), categorical and textual attributes like “source” and “destination” must be encoded before being used as training data. In one or more embodiments, this can be achieved by leveraging a LabelEncoder function of ScikitLearn library as shown in the pseudocode 1000 in FIG. 10.

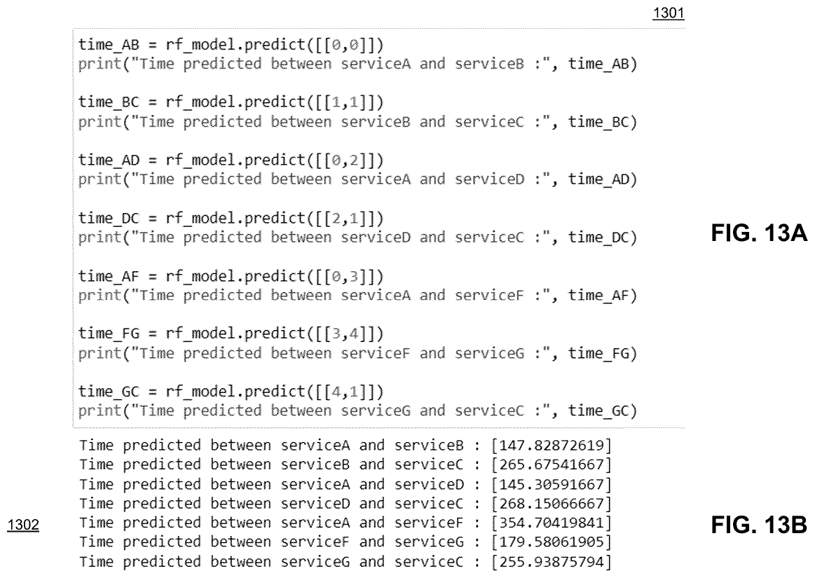

FIG. 11 depicts example pseudocode 1100 for splitting a dataset into training and testing components and for creating separate datasets for independent and dependent variables. The dataset is split into training and testing datasets using train_test_split function of ScikitLearn library with, for example, a 70%-30% split. FIG. 12 depicts example pseudocode 1200 for creating a random forest regressor and training the regressor model 141. FIG. 13A depicts example pseudocode 1301 for using the trained regressor model 141 to predict execution time for various service (e.g., microservice) combinations (e.g., service A and service B, service B and service C, service A and service D, etc.). FIG. 13B depicts predicted execution times 1302 for the various service combinations.

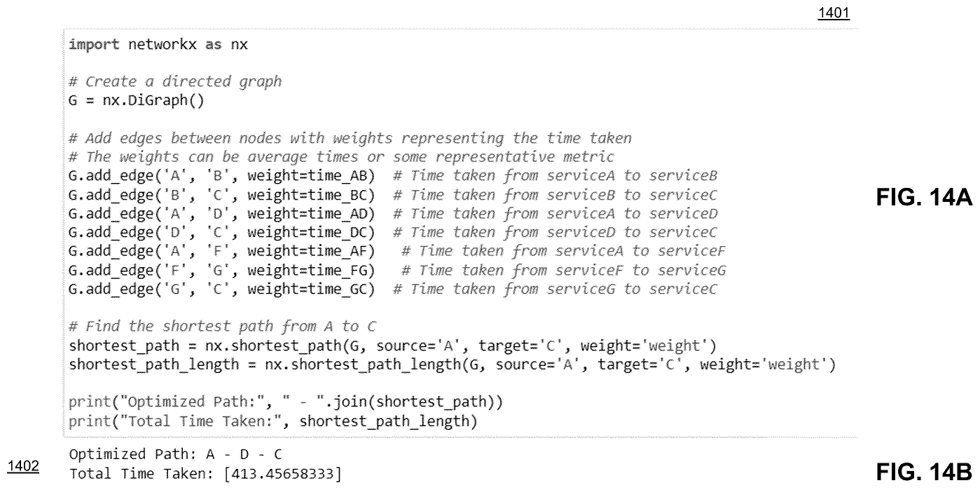

The predicted execution times between various service (e.g., microservice) combinations are used as input to the network graph model 142. FIG. 14A depicts example pseudocode 1401 for leveraging a network graph model to predict optimal network paths. In illustrative embodiments, Python code leveraging NetworkX, an open-source network graph model library, is used. In this code, between three possible call paths, the model predicts the optimal execution path based on the regressed execution time values of the services. As can be seen in the pseudocode 1401, a directed graph is created, edges are added between nodes with weights representing execution times. The pseudocode 1401 includes commands for finding the shortest path, which in this case, service A to service D to service C with a total time of about 413 ms. FIG. 14B depicts the predicted optimal network path 1402.

In some embodiments, the database 123, execution time data repository 150 and other data corpuses, repositories or databases referred to herein are implemented using one or more storage systems or devices associated with the network deployment recommendation platform 110. In some embodiments, one or more of the storage systems utilized to implement the database 123, the execution time data repository 150 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the network deployment recommendation platform 110, the dependency identification engine 120, unified instrumentation engine 130, network path prediction engine 140 and/or execution time data repository 150 in other embodiments can be implemented at least in part externally to the network deployment recommendation platform 110, for example, as stand-alone servers, sets of servers or other types of systems coupled to the network 104. For example, the dependency identification engine 120, unified instrumentation engine 130, network path prediction engine 140 and/or execution time data repository 150 may be provided as cloud services accessible by the network deployment recommendation platform 110.

The dependency identification engine 120, unified instrumentation engine 130, network path prediction engine 140 and/or execution time data repository 150 in the FIG. 1 embodiment are each assumed to be implemented using at least one processing device. Each such processing device generally comprises at least one processor and an associated memory, and implements one or more functional modules for controlling certain features of the dependency identification engine 120, unified instrumentation engine 130, network path prediction engine 140 and/or execution time data repository 150.

At least portions of the network deployment recommendation platform 110 and the elements thereof may be implemented at least in part in the form of software that is stored in memory and executed by a processor. The network deployment recommendation platform 110 and the elements thereof comprise further hardware and software required for running the network deployment recommendation platform 110, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the dependency identification engine 120, unified instrumentation engine 130, network path prediction engine 140, execution time data repository 150 and other elements of the network deployment recommendation platform 110 in the present embodiment are shown as part of the network deployment recommendation platform 110, at least a portion of the dependency identification engine 120, unified instrumentation engine 130, network path prediction engine 140, execution time data repository 150 and other elements of the network deployment recommendation platform 110 in other embodiments may be implemented on one or more other processing platforms that are accessible to the network deployment recommendation platform 110 over one or more networks. Such elements can each be implemented at least in part within another system element or at least in part utilizing one or more stand-alone elements coupled to the network 104.

It is assumed that the network deployment recommendation platform 110 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the dependency identification engine 120, unified instrumentation engine 130, network path prediction engine 140, execution time data repository 150 and other elements of the network deployment recommendation platform 110, and the elements thereof can each be implemented in the form of one or more LXCs running on one or more VMs. Other arrangements of one or more processing devices of a processing platform can be used to implement the dependency identification engine 120, unified instrumentation engine 130, network path prediction engine 140 and execution time data repository 150, as well as other elements of the network deployment recommendation platform 110. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the network deployment recommendation platform 110 to reside in different data centers. Numerous other distributed implementations of the network deployment recommendation platform 110 are possible.

Accordingly, one or each of the dependency identification engine 120, unified instrumentation engine 130, network path prediction engine 140, execution time data repository 150 and other elements of the network deployment recommendation platform 110 can each be implemented in a distributed manner so as to comprise a plurality of distributed elements implemented on respective ones of a plurality of compute nodes of the network deployment recommendation platform 110.

It is to be appreciated that these and other features of illustrative embodiments are presented by way of example only, and should not be construed as limiting in any way. Accordingly, different numbers, types and arrangements of system elements such as the dependency identification engine 120, unified instrumentation engine 130, network path prediction engine 140, execution time data repository 150 and other elements of the network deployment recommendation platform 110, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the network deployment recommendation platform can be offered to cloud infrastructure customers or other users as part of FaaS, CaaS and/or PaaS offerings.

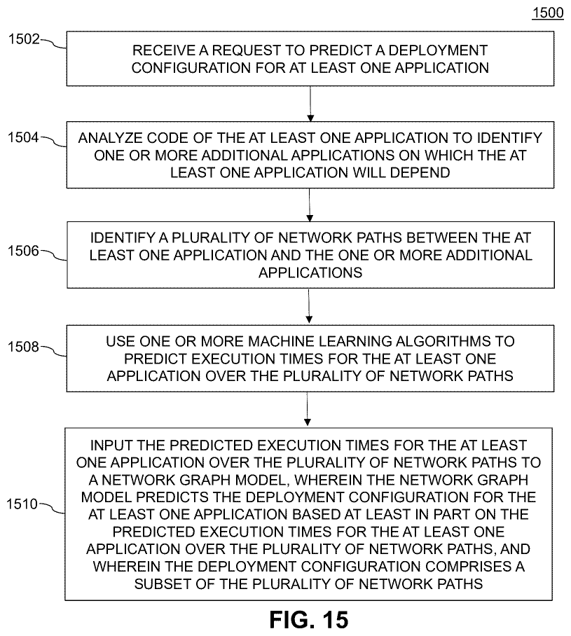

The operation of the information processing system 100 will now be described in further detail with reference to the flow diagram of FIG. 15. With reference to FIG. 15, a process 1500 for network deployment recommendation as shown includes steps 1502 through 1510, and is suitable for use in the system 100 but is more generally applicable to other types of information processing systems comprising a network deployment recommendation platform configured for selecting cloud providers and predicting optimal network paths.

In step 1502, a request to predict a deployment configuration for at least one application is received. The at least one application comprises at least one of an MFE application and a microservice application.

In step 1504, code of the at least one application is analyzed to identify one or more additional applications on which the at least one application will depend. The one or more additional applications comprise at least one of one or more MFE applications and one or more microservice applications. The one or more additional applications are deployed on one or more cloud platforms of a plurality of cloud platforms. Analyzing the code of the at least one application comprises identifying one or more protocol patterns in the code corresponding to at least one service call.

In step 1506, a plurality of network paths between the at least one application and the one or more additional applications are identified. In step 1508, one or more machine learning algorithms are used to predict execution times for the at least one application over the plurality of network paths.

In step 1510, the predicted execution times for the at least one application over the plurality of network paths are inputted to a network graph model, wherein the network graph model predicts the deployment configuration for the at least one application based at least in part on the predicted execution times for the at least one application over the plurality of network paths. The deployment configuration comprises a subset of the plurality of network paths.

In illustrative embodiments, the process further comprises collecting execution times for a plurality of applications, wherein the collecting comprises tracing respective network paths of the plurality of applications. The one or more machine learning algorithms are trained with the collected execution times for the plurality of applications. The one or more machine learning algorithms comprise a regression algorithm, and the process may further comprise using the regression algorithm to predict respective execution times between respective pairs of the plurality of applications. The predicted execution times for the at least one application over the plurality of network paths are based at least in part on one or more of the respective execution times between the respective pairs of the plurality of applications. The regression algorithm may comprise a random forest algorithm.

In illustrative embodiments, the network graph model graphs one or more of the respective pairs of the plurality of applications as respective node pairs, and the one or more of the respective execution times between the respective pairs of the plurality of applications as one or more respective edges between the respective node pairs. The one or more respective edges correspond to respective weights representing the one or more of the respective execution times. The network graph model can use a shortest path algorithm to predict the deployment configuration based at least in part on the respective weights. The network graph model uses a shortest path algorithm to predict the subset of the plurality of network paths.

It is to be appreciated that the FIG. 15 process and other features and functionality described above can be adapted for use with other types of information systems configured to execute network deployment recommendation services in a network deployment recommendation platform or other type of platform.

The particular processing operations and other system functionality described in conjunction with the flow diagram of FIG. 15 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 15 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a network deployment recommendation platform as disclosed herein can provide a number of significant advantages relative to conventional arrangements. For example, the network deployment recommendation platform uses machine learning to predict, in advance of cloud provisioning and application deployment, the functional and performance impact of a new application, API or other endpoint prior to deployment. The embodiments advantageously enable end-to-end call path visibility of an application prior to and at the time of deployment.

As an additional advantage, the embodiments introduce predictive insights on how applications and their dependencies will behave from a response time perspective factoring in each of the dependencies in a call path. Unlike conventional techniques, the embodiments leverage a machine learning-based regressor (e.g., random forest regressor), which is trained with historical execution time data captured by the tracing of each component in a call path. The framework predicts execution time, and predicts an optimal network path based on the execution time. The embodiments leverage a network graph model to predict the optimized execution path.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the network deployment recommendation platform 110 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a network deployment recommendation platform in illustrative embodiments. These and other cloud-based systems in illustrative embodiments can include object stores.

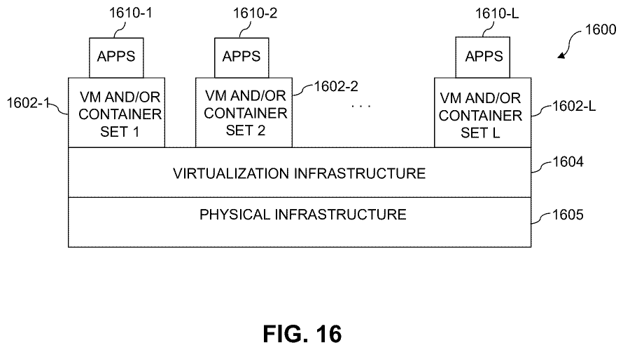

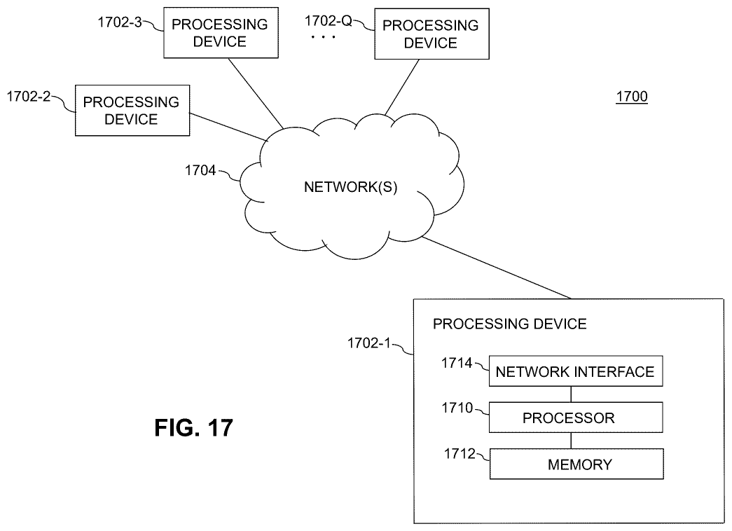

Illustrative embodiments of processing platforms will now be described in greater detail with reference to FIGS. 16 and 17. Although described in the context of system 100, these platforms may also be used to implement at least portions of other information processing systems in other embodiments. FIG. 16 shows an example processing platform comprising cloud infrastructure 1600. The cloud infrastructure 1600 comprises a combination of physical and virtual processing resources that may be utilized to implement at least a portion of the information processing system 100. The cloud infrastructure 1600 comprises multiple virtual machines (VMs) and/or container sets 1602-1, 1602-2, . . . 1602-L implemented using virtualization infrastructure 1604. The virtualization infrastructure 1604 runs on physical infrastructure 1605, and illustratively comprises one or more hypervisors and/or operating system level virtualization infrastructure. The operating system level virtualization infrastructure illustratively comprises kernel control groups of a Linux operating system or other type of operating system.

The cloud infrastructure 1600 further comprises sets of applications 1610-1, 1610-2, . . . 1610-L running on respective ones of the VMs/container sets 1602-1, 1602-2, . . . 1602-L under the control of the virtualization infrastructure 1604. The VMs/container sets 1602 may comprise respective VMs, respective sets of one or more containers, or respective sets of one or more containers running in VMs.

In some implementations of the FIG. 16 embodiment, the VMs/container sets 1602 comprise respective VMs implemented using virtualization infrastructure 1604 that comprises at least one hypervisor. A hypervisor platform may be used to implement a hypervisor within the virtualization infrastructure 1604, where the hypervisor platform has an associated virtual infrastructure management system. The underlying physical machines may comprise one or more distributed processing platforms that include one or more storage systems.

In other implementations of the FIG. 16 embodiment, the VMs/container sets 1602 comprise respective containers implemented using virtualization infrastructure 1604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1600 shown in FIG. 16 may represent at least a portion of one processing platform. Another example of such a processing platform is processing platform 1700 shown in FIG. 17.

The processing platform 1700 in this embodiment comprises a portion of system 100 and includes a plurality of processing devices, denoted 1702-1, 1702-2, 1702-3, . . . 1702-Q, which communicate with one another over a network 1704.

The network 1704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1702-1 in the processing platform 1700 comprises a processor 1710 coupled to a memory 1712. The processor 1710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1712 may comprise random access memory (RAM), read-only memory (ROM), flash memory or other types of memory, in any combination. The memory 1712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1702-1 is network interface circuitry 1714, which is used to interface the processing device with the network 1704 and other system components, and may comprise conventional transceivers.

The other processing devices 1702 of the processing platform 1700 are assumed to be configured in a manner similar to that shown for processing device 1702-1 in the figure.

Again, the particular processing platform 1700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the network deployment recommendation platform 110 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and network deployment recommendation platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a request to predict a deployment configuration for at least one application;
analyzing code of the at least one application to identify one or more additional applications on which the at least one application will depend;
identifying a plurality of network paths between the at least one application and the one or more additional applications;
using one or more machine learning algorithms to predict execution times for the at least one application over the plurality of network paths; and
inputting the predicted execution times for the at least one application over the plurality of network paths to a network graph model, wherein the network graph model predicts the deployment configuration for the at least one application based at least in part on the predicted execution times for the at least one application over the plurality of network paths, and wherein the deployment configuration comprises a subset of the plurality of network paths; and
wherein the steps of the method are executed by a processing device operatively coupled to a memory.

2. The method of claim 1 wherein the at least one application comprises at least one of a micro-frontend application and a microservice application.

3. The method of claim 1 wherein the one or more additional applications comprise at least one of one or more micro-frontend applications and one or more microservice applications, and wherein the one or more additional applications are deployed on one or more cloud platforms of a plurality of cloud platforms.

4. The method of claim 1 wherein analyzing the code of the at least one application comprises identifying one or more protocol patterns in the code corresponding to at least one service call.

5. The method of claim 1 further comprising collecting execution times for a plurality of applications.

6. The method of claim 5 wherein the collecting comprises tracing respective network paths of the plurality of applications.

7. The method of claim 5 further comprising training the one or more machine learning algorithms with the collected execution times for the plurality of applications.

8. The method of claim 5 wherein:
the one or more machine learning algorithms comprise a regression algorithm; and
the method further comprises using the regression algorithm to predict respective execution times between respective pairs of the plurality of applications.

9. The method of claim 8 wherein the predicted execution times for the at least one application over the plurality of network paths are based at least in part on one or more of the respective execution times between the respective pairs of the plurality of applications.

10. The method of claim 8 wherein:
the network graph model graphs one or more of the respective pairs of the plurality of applications as respective node pairs;
the network graph model graphs the one or more of the respective execution times between the respective pairs of the plurality of applications as one or more respective edges between the respective node pairs; and
the one or more respective edges correspond to respective weights representing the one or more of the respective execution times.

11. The method of claim 10 wherein the network graph model uses a shortest path algorithm to predict the deployment configuration based at least in part on the respective weights.

12. The method of claim 8 wherein the regression algorithm comprises a random forest algorithm.

13. The method of claim 1 wherein the network graph model uses a shortest path algorithm to predict the subset of the plurality of network paths.

14. An apparatus comprising:
a processing device operatively coupled to a memory and configured:
to receive a request to predict a deployment configuration for at least one application;
to analyze code of the at least one application to identify one or more additional applications on which the at least one application will depend;
to identify a plurality of network paths between the at least one application and the one or more additional applications;
to use one or more machine learning algorithms to predict execution times for the at least one application over the plurality of network paths; and
to input the predicted execution times for the at least one application over the plurality of network paths to a network graph model, wherein the network graph model predicts the deployment configuration for the at least one application based at least in part on the predicted execution times for the at least one application over the plurality of network paths, and wherein the deployment configuration comprises a subset of the plurality of network paths.

15. The apparatus of claim 14 wherein the processing device is further configured to collect execution times for a plurality of applications.

16. The apparatus of claim 15 wherein:
the one or more machine learning algorithms comprise a regression algorithm; and
the processing device is further configured to use the regression algorithm to predict respective execution times between respective pairs of the plurality of applications.

17. The apparatus of claim 16 wherein:
the network graph model graphs one or more of the respective pairs of the plurality of applications as respective node pairs;
the network graph model graphs the one or more of the respective execution times between the respective pairs of the plurality of applications as one or more respective edges between the respective node pairs; and
the one or more respective edges correspond to respective weights representing the one or more of the respective execution times.

18. An article of manufacture comprising a non-transitory processor-readable storage medium having stored therein program code of one or more software programs, wherein the program code when executed by at least one processing device causes said at least one processing device to perform the steps of:
receiving a request to predict a deployment configuration for at least one application;
analyzing code of the at least one application to identify one or more additional applications on which the at least one application will depend;
identifying a plurality of network paths between the at least one application and the one or more additional applications;
using one or more machine learning algorithms to predict execution times for the at least one application over the plurality of network paths; and
inputting the predicted execution times for the at least one application over the plurality of network paths to a network graph model, wherein the network graph model predicts the deployment configuration for the at least one application based at least in part on the predicted execution times for the at least one application over the plurality of network paths, and wherein the deployment configuration comprises a subset of the plurality of network paths.

19. The article of manufacture of claim 18 wherein the program code further causes said at least one processing device to perform the step of collecting execution times for a plurality of applications.

20. The article of manufacture of claim 19 wherein:
the one or more machine learning algorithms comprise a regression algorithm; and
the program code further causes said at least one processing device to perform the step of using the regression algorithm to predict respective execution times between respective pairs of the plurality of applications.
